(19) United States
(12) Patent Application Publication
(10) Pub. No.: US 2026/0352493 A1
(43) Pub. Date: Nov. 5, 2026

(54) MEMORY MODULE VERIFICATION USING MODULE-RELATED INFORMATION

(71) Applicant: HEWLETT PACKARD ENTERPRISE DEVELOPMENT LP, Spring, TX (US)

(72) Inventors: Lee A. Preimesberger, Houston, TX (US); Vartan Yosef Kasheshian, Houston, TX (US); Jonathan Rene Mooty, Houston, TX (US); Grant Tavis O'Connor, Spring, TX (US); Eric L. Pope, Tomball, TX (US)

(21) Appl. No.: 19/195,882

(22) Filed: May 1, 2025

(51) Int. Cl. H04L 9/32; H04L 9/00

(52) U.S. Cl. CPC H04L 9/3263; H04L 9/006; H04L 9/3236

(57) ABSTRACT

In some examples, an electronic device obtains a certificate issued by a certificate authority. Based on the certificate, the electronic device triggers a memory module verification process, and accesses, as part of the memory module verification process, memory module-related information from a memory module of the electronic device. The electronic device determines a verification status of the memory module based on the memory module-related information. Activation of the memory module is controlled based on the verification status.

### BACKGROUND

An electronic device can include a memory module that has memory devices to store information. The memory module is accessible to various electronic components, such as a central processing unit (CPU), an input/output (I/O) device, or another type of device.

### BRIEF DESCRIPTION OF THE DRAWINGS

Some implementations of the present disclosure are described with respect to the following figures.

FIG. 1 is a block diagram of an arrangement including an electronic device and a public key infrastructure (PKI), according to some examples.

FIG. 2 is a flow diagram of a manifest setup process, according to some examples.

FIG. 3 is a flow diagram of a validation process for validating a memory module, according to some examples.

FIG. 4 is a block diagram of a storage medium storing machine-readable instructions according to some examples.

FIG. 5 is a block diagram of an electronic device according to some examples.

FIG. 6 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A memory module in an electronic device may be subjected to tampering. For example, the entire memory module may be removed and replaced with a different memory module. As another example, one or more memory devices in the memory module may be removed and replaced with unauthorized memory devices. A replacement memory device may have a lower performance or may have technical specifications that may not be satisfactory. In a further example, a replacement memory device may contain malicious code or other unauthorized information. A user may not detect any component change in the memory module until a negative behavior is experienced during an operation of the electronic device. Unauthorized changes to a memory module that lead to suboptimal or faulty operation of an electronic device may harm the reputation of the manufacturer of the electronic device or may lead to costly diagnostic and repair tasks due to the time spent by personnel and replacement part costs. Further, unauthorized changes to a memory module may allow an attacker to gain access to an electronic device for performing unauthorized operations using the electronic device.

In accordance with some implementations of the present disclosure, a security mechanism for a memory module in an electronic device triggers a memory module verification process based on a certificate issued by a certificate authority (CA). In some examples, the CA is part of a public key infrastructure (PKI). The certificate can include feature control metadata that indicates that memory module verification is to be performed prior to enabling the memory module. The electronic device includes a controller to access, as part of the memory module verification process, memory module-related information from the memory module. The memory module-related information may include information elements from various components in the memory module. The controller determines a verification status of the memory module based on the memory module-related information, and the controller controls activation of the memory module based on the verification status. For example, if the verification status indicates that the memory module-related information has been validated, the controller can enable power to the memory module. On the other hand, if the verification status indicates that the memory module-related information is not validated, the controller can disable power to the memory module. Enabling or disabling power to the memory module may be accomplished by controlling a power supply that outputs a power control signal to the memory module.

In some examples, the information elements in the memory module-related information include identifiers of multiple different types of components in the memory module. The information elements of the multiple different types of components can additionally include other types of information, including manufacturer-added information added by a manufacturer of the memory module, static information such as static machine-readable instructions, or other information. The multiple different types of components in the memory module can include at least one memory device and at least one module control device (and possibly other components as discussed further below). A module control device can perform a control task with respect to memory device(s) of the memory module. Determining a verification status of the memory module based on the memory module-related information can involve computing measurement values based on the information elements of the multiple components in the memory module.

The CA of the public key infrastructure (PKI) is a root of trust that provides a signed certificate. By leveraging the signed certificate from the PKI to trigger a memory module verification process by the controller, trust of the memory module verification process can be established since the controller would have to successfully decrypt the signed certificate. The ability of the controller to decrypt the signed certificate indicates that the controller has not been compromised (e.g., swapped out with another controller or corrupted with malicious code). The PKI provides an extra trust mechanism beyond physical access and provision of a credential to initiate the memory module verification process. Techniques or mechanisms according to some examples of the present disclosure improve computer functionality or the relevant technology by providing a trusted process to verify a memory module in an electronic device to detect and disable a compromised memory module.

A “memory module” can refer to an assembly that includes one or more memory devices. In some examples, a memory module may include a support structure (e.g., a circuit board) on which one or more memory devices and related components are mounted. In other examples, the memory module may be an integrated circuit device including one or more memory devices in the form of dies. Examples of memory modules include a Dual In-line Memory Module (DIMM), a Compression Attached Memory Module (CAMM), or other types of memory modules.

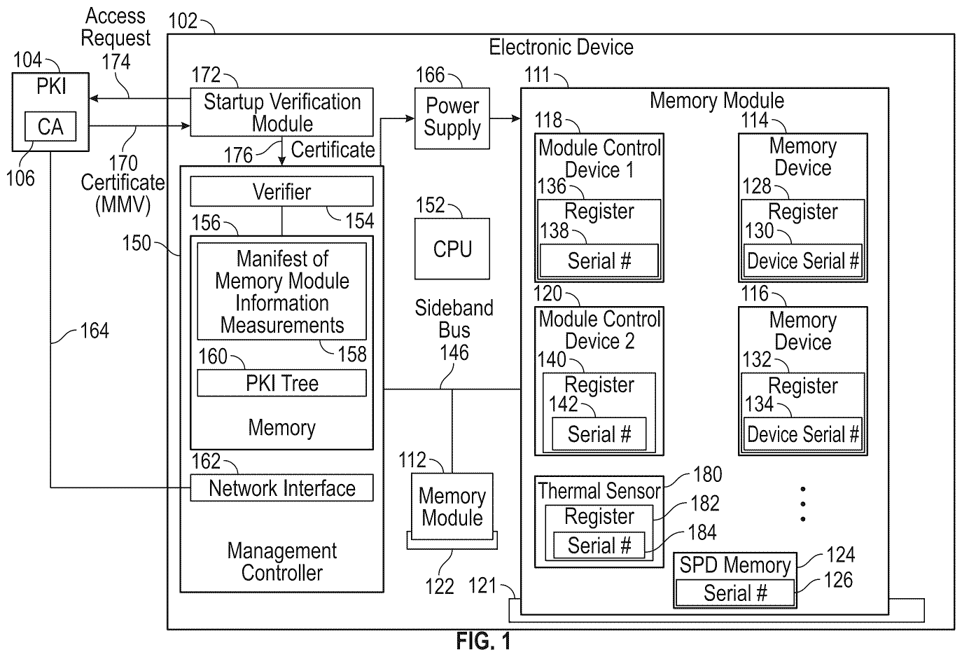

FIG. 1 is a block diagram of an example arrangement that includes an electronic device 102 and a PKI 104. The PKI 104 is an example of a system (implemented with one or more computers) that manages the issuance of certificates and the binding of target electronic devices, such as the electronic device 102, to a security key hierarchy (e.g., a PKI tree), to enable selective access control of electronic device features. The PKI 104 includes a CA 106 that issues certificates.

Although just one electronic device 102 is depicted in FIG. 1, it is noted that there may be multiple electronic devices in other examples. For example, a facility can include a large quantity of electronic devices with memory modules that are to be verified.

The electronic device 102 includes memory modules 111 and 112. Although two memory modules are shown in FIG. 1, in other examples, a different quantity (1 or more than 2) of memory modules may be included in the electronic device 102. In examples according to FIG. 1, the memory module 111 is connected to a memory module connector 121, and the memory module 112 is connected to a memory module connector 122. A memory module connector may be in the form of a slot, a plug, or any other type of electrical connector.

The memory module connectors 121 and 122 may be arranged on a circuit board (e.g., a motherboard, a midplane, a backplane, etc.) of the electronic device 102. Alternatively, the memory module connectors 121 and 122 may be part of a larger memory module, such as Compute Express Link (CXL) memory module that has memory module connectors for receiving memory modules.

The memory module 111 includes memory devices 114 and 116. In a different example, the module 111 may include just one memory device 114 or more than two memory devices. A memory device can be in the form of a packaged memory chip, a memory die, or any other type of memory device.

FIG. 1 shows various components of the memory module 111. The memory module 112 can include a similar arrangement of components as the memory module 111.

The memory module 111 also includes module control devices 118 and 120. A module control device can perform a control task with respect to the memory devices 114 and 116 of the memory module 111. In some examples, the module control device 118 is a Registered Clock Driver (RCD) that receives memory access instructions from a requester, such as a central processing unit (CPU), an input/output (I/O) device, or another requester in the electronic device 102. The RCD temporarily holds the received memory access instructions, such as for one clock cycle, and transfers the memory access instructions to one or more of the memory devices 114 and 116 for access of data stored in the memory device(s).

An example of the module control device 120 is a power management device, such as a power management integrated circuit (PMIC), that performs a power management task in the memory module 111. For example, the PMIC receives an input power voltage that is at a first voltage level. The input power voltage can be received from a power supply 166 of the electronic device 102. Based on the input power voltage, the PMIC generates one or more output voltages that are used to power components of the memory module 111, including the memory devices 114 and 116. A power voltage generated by the PMIC may be at a different voltage level than the input power voltage.

Although specific examples of module control devices are discussed, it is noted that the memory module 111 can include alternative or additional module control devices in other examples.

The memory module 111 further includes a serial presence detect (SPD) memory 124, which contains SPD data. The SPD memory can include an electrically erasable and programmable read-only memory (EEPROM) or another type of nonvolatile memory. Examples of SPD data include timing parameters for the memory module 111, manufacturer information of a manufacturer of the memory module 111, a module serial number 126 of the memory module 111, and/or other information relating to the memory module 111. A “serial number” is an example of a unique identifier that can uniquely identify a specific item. In other examples, other types of unique identifiers may be employed. In some examples, the SPD memory 124 may be separate from the module control devices 118 and 120. In other examples, the SPD memory 124 may be part of the module control device 118 or 120 (e.g., the SPD functionality and one or more module control functionalities may be integrated into a single chip).

The memory module 111 may further include a thermal sensor 180 that can detect a temperature of the memory module 111. In further examples, the memory module 111 may include alternative or additional components.

At least some of the components may include serial numbers of the components. For example, each of the memory devices 114 and 116, the module control devices 118, 120, and the thermal sensor 180 may include a respective serial number (or another type of unique identifier of the respective component).

In the example of FIG. 1, the memory device 114 has a register 128 that stores a device serial number 130, and the memory device 116 has a register 132 that stores a device serial number 134. The device serial numbers 130 and 134 identify the memory devices 114 and 116, respectively.

The module control device 118 includes a register 136 that stores a control device serial number 138 that identifies the module control device 118, and the module control device 120 includes a register 140 that stores a control device serial number 142 that identifies the module control device 120. Similarly, the thermal sensor 180 includes a register 182 that stores a sensor serial number 184.

The serial numbers included in the various different types of components of the memory module 111 are examples of module-related information that can be used to verify the integrity of the memory module 111. In other examples, alternative or additional module-related information can be used for verifying the integrity of the memory module 111. For example, other module-related information may include information stored in the memory module 111 by a manufacturer of the memory module, static information such as static machine-readable instructions or other data in the memory module 111, and so forth. Similar module-related information in the memory module 112 can be used to verify the integrity of the memory module 112. In some examples of the present disclosure, the verification of the integrity of a memory module is based on measurements of information elements of different types of components of the memory module, including memory device(s), module control device(s), and so forth.

In examples of the present disclosure, the verification of the integrity of the memory module 111 or 112 can be performed by the management controller 150. An example of the management controller 150 is a baseboard management controller (BMC). In other examples, other types of controllers can be used for verifying the integrity of memory modules. For example, the other types of controllers can include a security processor that may be provided in a secure enclave protected by a cryptographic boundary inside the electronic device 102. Further, the verification of memory modules can be performed by program code executed by a CPU 152 of the electronic device 102. The management controller 150 performs various management-related tasks in the electronic device 102. The management controller 150 is separate from the CPU 152.

The CPU 152 executes primary machine-readable instructions of the electronic device 102, such as an operating system (OS), an application program, or system firmware. The system firmware can include Basic Input/Output System (BIOS) code or Universal Extensible Firmware Interface (UEFI) code, for example. “Primary” machine-readable instructions are distinct (and separate) from machine-readable instructions (such as firmware or software) executable by other electronic components, such as the management controller 150.

The management controller 150 executes a verifier 154 that performs the verification of the integrity of a memory module (e.g., 111 or 112) in the electronic device 102. The management controller 150 includes a memory 156 that can be implemented using one or more memory devices. The memory 156 stores certain information used by the verifier 154, including a manifest 158 of memory module information measurements and a PKI tree 160.

The memory module information measurements of the manifest 158 include reference measurement values derived by applying a function on certain information elements of the memory module 111, such as the serial numbers 126, 130, 134, 138, 142, and 184 (or any other combination of information elements in the memory module 111). In some examples, the function applied can be a cryptographic hash function, such as a Secure Hash Algorithm (SHA) function. A cryptographic hash function applied on a specific information element, such as a serial number, produces a respective hash value. Thus, the manifest 158 can contain reference hash values derived from applying the cryptographic hash function on respective serial numbers 126, 130, 134, 138, 142, and 184.

In some examples, the manifest 158 can be in the form of a tree, such as a Merkel tree. The tree can include nodes that contain respective reference hash values. In other examples, the manifest 158 is a data structure of a different form (e.g., a table, a text document, etc.), where the data structure has entries containing respective reference hash values.

The management controller 150 also includes a network interface 162 to allow the management controller 150 to communicate with an entity, such as the PKI 104, outside the electronic device 102. The network interface 162 includes a signal transceiver to send and transmit signals, as well as one or more protocol layers that govern communication of data according to respective communication protocols.

The management controller 150 can access the module-related information of the memory module 111 or 112 over a sideband bus 146. The sideband bus 146. In some examples, the sideband bus 146 can include any of the following: an Inter-Integrated Component (I²C) bus, an Improved I²C (I³C) bus, a system management bus (SMB), or any other type of bus over which management tasks can be performed with respect to a memory module.

The sideband bus 146 is separate from a primary bus that the CPU 152 or another device uses to access data stored in the memory devices of the memory modules 111 and 112. The primary bus may be connected to the memory module connectors 121 and 122.

The CA 106 in the PKI 104 is a trusted third party that can be used to produce certificates that can allow entities, such as the management controller 150, to access electronic device features of the electronic device 102, including checking the integrity of memory modules and enabling or disabling access to the memory modules.

The PKI 104 can set up (at 164) the PKI tree 160 in the management controller 150. The PKI 104 can interact with the management controller 150 through the network interface 162 and over a management network. The management network is a secondary network to which the electronic device 102 is connected.

The electronic device 102 can include a network interface (not shown) that is connected to a primary network separate from the management network. The primary network is used by the electronic device 102 to perform communications associated with normal operations of the electronic device 102, such as operations performed by the primary machine-readable instructions of the electronic device 102. “Normal” operations can refer to operations of the electronic device 102 that are different from management operations of a management controller such as the management controller 150.

Setting up the PKI tree 160 in the management controller 150 binds the PKI tree 160 to the electronic device 102. Once the PKI tree 160 is installed in the management controller 150, the management controller 150 can selectively enable or disable access to electronic device features including access to the memory modules 111 and 112.

Certificates can be generated by the CA 106 based on keys that are represented in the PKI tree 160. The PKI tree 160 includes a hierarchical arrangement of nodes that represent different entities, including users, user groups, electronic components, or other entities. Each node is associated with a key that is assigned to the entity. A key in the PKI tree 160 can include a public-private key pair that has a public key and the corresponding private key.

A “key” can refer to a collection of values (a single value or multiple values) that can be used to obtain a certificate to support secure access to an electronic device. In some examples, a key can refer to a public-private key pair that includes a public key and the associated private key.

A “certificate” can refer to information that is used to secure communications, such as between an access device and a target electronic device. In some examples, certificates can be X.509 certificates according to the X.509 protocol, which is provided by the International Telecommunication Union (ITU) and defines the format of public key certificates. An X.509 certificate binds an identity to a public key using a digital signature. A certificate contains an identity (a hostname, or an identity of an organization or an individual) and a public key, and the certificate can be signed by a CA. When a certificate is signed by a trusted CA, an entity holding the certificate can use the public key contained in the certificate to establish secure communications with another entity.

In accordance with some examples of the present disclosure, a certificate such as an X.509 certificate is extended to add access control metadata, which can be in the form of object identifier (OID) metadata according to X.509, for example. The access control metadata can include one or more feature control information elements (in the form of values of OIDs, for example) that specify access control of electronic device features. More specifically, an X.509 certificate includes an Extensions field, which is a sequence of one or more certificate extensions. Each certificate extension has its own unique identifier, expressed as an OID. An OID includes a set of values. In some examples of the present disclosure, one or more values of an OID can be used as a feature control information element (or more generally, access control metadata) to perform access control of an electronic device feature.

For example, a feature control information element (represented as MMV in FIG. 1) included in a certificate 170 issued by the CA 106 can be set to an active value (e.g., “1” or “0”) to indicate that the management controller 150 is to initiate a memory module verification process. If the feature control information element is set to an inactive value (e.g., “0” or “1”) different from the active value, the management controller 150 would not initiate the memory module verification process.

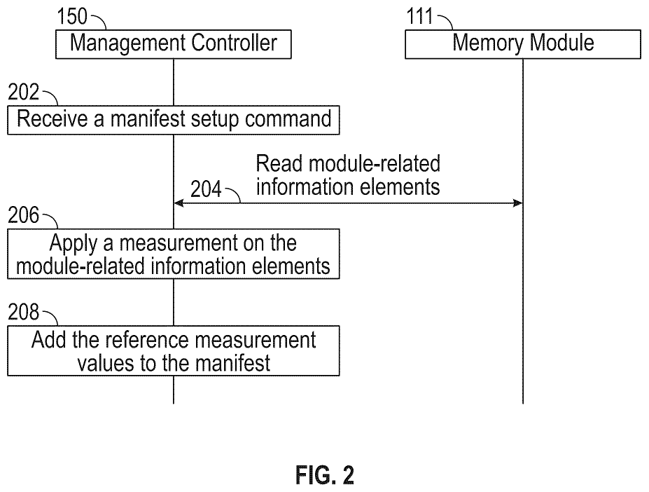

The following refers to FIG. 1 and FIG. 2. FIG. 2 is a flow diagram of a manifest setup process for establishing the manifest 158 of memory module information measurements. The manifest setup process can be performed during the manufacture of the electronic device 102, during a configuration (or reconfiguration) stage of the electronic device 102, or in any other phase of the electronic device 102 when the electronic device 102 is expected to be in a secure (untampered) state. The manifest setup process involves the management controller 150 and the memory module 111. A similar process may be performed with respect to the memory module 112.

In response to receiving (at 202) a command to setup the manifest 158 (e.g., issued by a human, a program, or a machine), the verifier 154 in the management controller 150 accesses (e.g., over the sideband bus 146) the memory module 111 to read (at 204) module-related information elements from the memory module 111. The module-related information elements that are read can include any or some combination of the following: the serial numbers 126, 130, 134, 138, 142, 184, and/or any other module-related information.

The verifier 154 applies (at 206) a measurement (e.g., a cryptographic hash function) on the module-related information elements to produce respective reference measurement values (e.g., hash values). The verifier 154 adds (at 208) the reference measurement values to the manifest 158 stored in the memory 156.

At this point, the manifest setup process completes, and the electronic device 102 can be delivered to a customer for use.

After delivery of the electronic device 102 to the customer, it is possible that an authorized update is made of the memory module 111 or 112. For example, a memory module may be replaced, or a component in the memory module may be replaced. This authorized update can be performed by a technician with a privilege (e.g., credentials, certificates, etc.) to initiate another manifest setup process, which updates the manifest 158 with updated memory module information measurements.

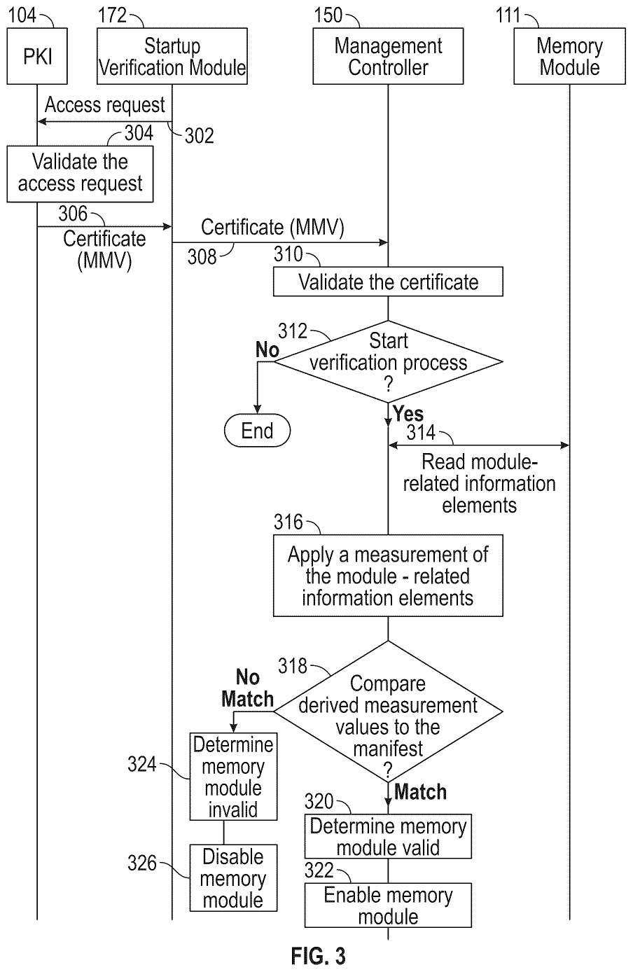

The following refers to FIG. 1 and FIG. 3. FIG. 3 is a flow diagram of a validation process for validating the memory module 111. A similar validation process may be performed with respect to the memory module 112. The validation process may be performed on each startup (e.g., boot) of the electronic device 102, or at other times (e.g., in response to a user request or another event). The validation process of FIG. 3 involves the PKI 104, a startup verification module 172 in the electronic device 102, the management controller 150, and the memory module 111.

The validation process of FIG. 3 may be performed during a startup of the electronic device 102. To start the memory module verification process, the startup verification module 172 of the electronic device 102 can send (at 302) an access request 174 to the PKI 104 over a network to obtain a certificate. In some examples, the startup verification module 172 can be part of the system firmware (e.g., the BIOS code or the UEFI code) of the electronic device 102. In other examples, the startup verification module 172 can be part of the management controller 150 or another controller. The startup verification module 172 can be initiated during the startup of the electronic device 102. The startup verification module 172 can present a user interface through which a user can provide an input (e.g., by selecting a control element of the user interface or inputting a command into a field of the user interface) requesting the memory module verification process. Alternatively, the startup verification module 172 can start the memory module verification process automatically without any user input.

In some examples, the access request 174 can include a certificate signing request (CSR), which is a request that seeks the issuance of a certificate. The CA 106 validates (at 304) the access request 174. For example, the CSR may be signed by the startup verification module 172 using a private key. The CA 106 can validate the signed CSR using a corresponding public key. In response to successful validation of the access request 174, the CA 106 issues the certificate 170 that is sent (at 306) from the CA 106 to the startup verification module 172. The certificate 170 may be signed using a private key of the CA 106.

In accordance with some examples of the present disclosure, the CA 106 sets a feature control information element (represented as MMV in FIG. 1) in the certificate 170 to indicate that a memory module verification process is requested. The feature control information element (MMV) may be part of an OID of the certificate 170 (e.g., an X.509 certificate), for example. The feature control information element (MMV) can be set to one of several different values (e.g., active value and inactive value), which can specify whether or not the memory module verification process is to be triggered.

The startup verification module 172 sends (at 308) the certificate 170 received from the CA 106 to the management controller 150. The certificate sent from the startup verification module 172 to the management controller 150 is labeled 176 in FIG. 1. Note that the certificate 176 is signed by CA's private key.

The verifier 154 in the management controller 150 decrypts the signed certificate 176 using the CA's public key retrieved from the PKI tree 160. The verifier 154 validates (at 310) the certificate 176 if the verifier 154 successfully decrypts the signed certificate 176.

In response to validating the certificate 176, the verifier 154 determines (at 312), based on the state of the feature control information element (MMV) from the certificate 176, whether the memory module verification process is to be started. If MMV is set to the inactive value, then the memory module verification process is not started, and the process ends. However, if MMV is set to the active value, the verifier 154 starts (at 312) the memory module verification process.

As part of the memory module verification process, the verifier 154 accesses the memory module 111 (e.g., over the sideband bus 146) to read (at 314) module-related information elements from the memory module 111. The module-related information elements that are read can include any or some combination of the following: the serial numbers 126, 130, 134, 138, 142, 184, and/or any other module-related information.

The verifier 154 applies (at 316) a measurement (e.g., a cryptographic hash function) on the module-related information elements to produce respective derived measurement values (e.g., hash values). The verifier 154 compares (at 318) the derived measurement values to respective reference measurement values in the manifest 158 stored in the memory 156. If the derived measurement values match the respective reference measurement values in the manifest 158, the verifier 154 makes a determination (at 320) that the memory module 111 is valid. In response, the management controller 150 enables (at 322) the memory module 111. Enabling the memory module 111 can refer to maintaining power (from the power supply 166) to the memory module 111 so that the memory module 111 can continue to operate.

If the derived measurement values do not match the respective reference measurement values in the manifest 158, the verifier 154 makes a determination (at 324) that the memory module 111 is invalid. In response, the management controller 150 disables (at 326) the memory module 111. Disabling the memory module 111 can refer to removing power (of the power supply 166) from the memory module 111 so that the memory module 111 can no longer operate. The management controller 150 can also send an alert to a target entity (e.g., a human administrator, a program, or a machine) indicating that the memory module 111 is compromised.

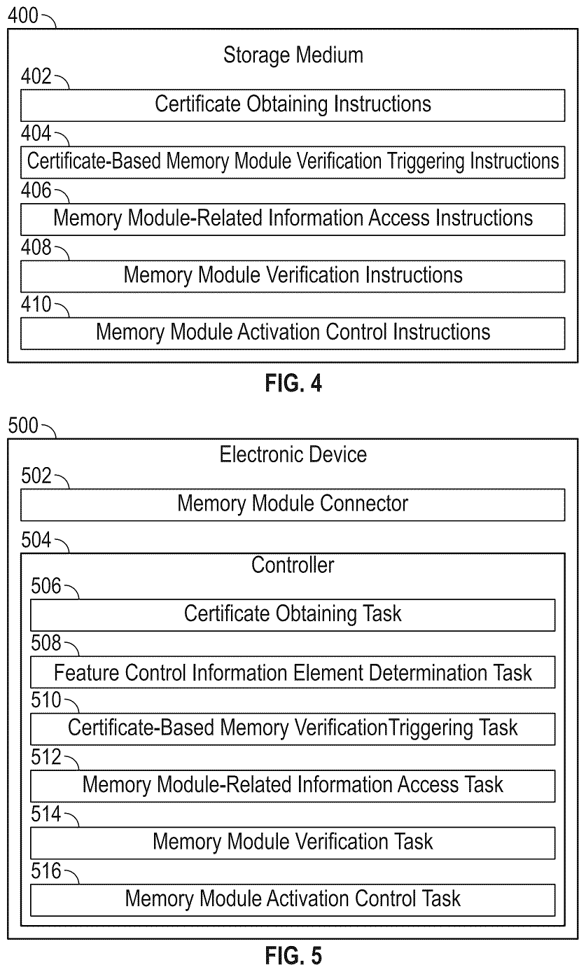

FIG. 4 is a block diagram of a non-transitory machine-readable or computer-readable storage medium 400 storing machine-readable instructions that upon execution cause an electronic device to perform various tasks. An example of the electronic device is the electronic device 102 of FIG. 1. The machine-readable instructions can include the startup verification module 172 and the verifier 154 of FIG. 1, for example.

The machine-readable instructions include certificate obtaining instructions 402 to obtain a certificate issued by a CA. The certificate can be obtained by sending an access request (e.g., a CSR) to the CA.

The machine-readable instructions include certificate-based memory module verification triggering instructions 404 to trigger, based on the certificate, a memory module verification process. In some examples, the certificate includes a feature control information element (e.g., MMV) settable to an active value to indicate that the memory module verification process of the memory module is to be triggered.

The machine-readable instructions include memory module-related information access instructions 406 to access, as part of the memory module verification process, memory module-related information from a memory module of the electronic device. The memory module-related information includes a plurality of information elements from a plurality of different types of components in the memory module.

The machine-readable instructions include memory module verification instructions 408 to determine a verification status of the memory module based on measurements of the plurality of information elements from the plurality of different types of components in the memory module. In some examples, measurement values derived from the measurements of the plurality of information elements can be compared to reference measurement values to determine the verification status.

The machine-readable instructions include memory module activation control instructions 410 to control activation of the memory module based on the verification status (memory module valid or invalid). If the memory module is determined to be valid, the machine-readable instructions can enable the memory module. If the memory module is determined to be invalid, the machine-readable instructions can disable the memory module.

In some examples, the triggering of the memory module verification process, the accessing of the memory module-related information, the determining of the verification status of the memory module, and the controlling of the activation of the memory module are performed by a management controller.

In some examples, the certificate is obtained during a startup of the electronic device, and the certificate is signed with a private key.

In some examples, the management controller can validate the signed certificate using a public key obtained from a PKI that includes the CA.

In some examples, the memory module-related information includes information from a module control device that is a member of the plurality of different types of components in the memory module, the module control device to perform a control task relative to memory devices in the memory module.

For example, the module control device can include an RCD to receive a memory access instruction from a requester and send the memory access instruction to a memory device in the memory module. As a further example, the module control device can include a power management control module (e.g., a PMIC) to manage power for the memory devices in the memory module.

In some examples, the memory module-related information can include information from an SPD memory (e.g., 124 in FIG. 1) that is a member of the plurality of different types of components in the memory module.

In some examples, the memory module-related information can include identification information (e.g., a serial number) from a memory device that is a member of the plurality of different types of components in the memory module. If the memory module has multiple memory devices, each memory device can have its individual identification information.

In some examples, the electronic device can determine the verification status of the memory module based on comparing a value derived from the memory module-related information to a reference value in a manifest stored in the electronic device.

In some examples, the manifest was created during a manufacture of the electronic device. In further examples, the manifest was populated responsive to an authorized update of the memory module.

FIG. 5 is a block diagram of an electronic device 500 according to some examples of the present disclosure. An example of the electronic device 500 is the electronic device 102 of FIG. 1.

The electronic device 500 includes a memory module connector 502 for a memory module. The electronic device 500 further includes a controller 504 to perform various tasks. An example of the controller 504 is the controller 150 of FIG. 1.

The tasks of the controller 504 include a certificate obtaining task 506 to obtain a certificate issued by a CA. The controller 504 can obtain the certificate in response to an event (e.g., a boot, a request, etc.) indicating that a verification of the memory module is to be performed.

The tasks of the controller 504 include a feature control information element determination task 508 to determine a value of a feature control information element in the certificate. The value may be an active value or an inactive value.

The tasks of the controller 504 include a certificate-based memory module verification task 510 to trigger, based on the value of the feature control information element in the certificate, a memory module verification process. For example, if the feature control information element in the certificate is set to the active value, the memory module verification process is triggered.

The tasks of the controller 504 include a memory module-related information access task 512 to access, as part of the memory module verification process, memory module-related information from the memory module. The memory module-related information can include memory module-related information elements from respective components in the memory module.

The tasks of the controller 504 include a memory module verification task 514 to determine a verification status of the memory module based on the memory module-related information.

The tasks of the controller 504 include a memory module activation control task 516 to control activation of the memory module based on the verification status. The memory module may be enabled or disabled based on the verification status.

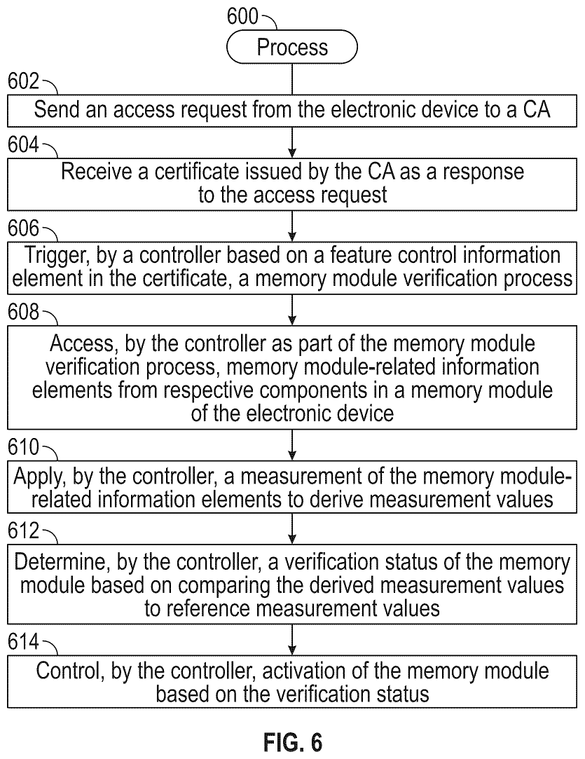

FIG. 6 is a flow diagram of a process 600 according to some examples of the present disclosure. The process 600 can be performed by an electronic device, such as the electronic device 102 of FIG. 1.

The process 600 includes sending (at 602) an access request from the electronic device to a CA. The access request may be a CSR, for example.

The process 600 includes receiving (at 604), at the electronic device, a certificate issued by the CA as a response to the access request. The certificate can include a feature control information element.

The process 600 includes triggering (at 606), by a controller based on a feature control information element in the certificate, a memory module verification process. The triggering of the memory module verification process can be based on the feature control information element being set to an active value.

The process 600 includes accessing (at 608), by the controller as part of the memory module verification process, memory module-related information elements from respective components in a memory module of the electronic device.

The process 600 includes applying (at 610), by the controller, a measurement of the memory module-related information elements to derive measurement values. The measurement can include applying a function to the memory module-related information elements.

The process 600 includes determining (at 612), by the controller, a verification status of the memory module based on comparing the derived measurement values to reference measurement values. The verification status is valid if the derived measurement values match reference measurement values. The verification status is invalid if the derived measurement values do not match reference measurement values.

The process 600 includes controlling (at 614), by the controller, activation of the memory module based on the verification status. For example, the controller can enable the memory module if the memory module is valid. The controller can disable the memory module if the memory module is invalid.

An “electronic device” can refer to any of the following: a desktop computer, a notebook computer, a storage system, a communication node, a vehicle, a household appliance, or another type of electronic device.

A “register” can refer to a storage element that can store data. The register can be implemented with latches, as part of a memory, or with any other type of storage element.

A “controller” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, a “controller” can refer to a combination of one or more hardware processing circuits and machine-readable instructions (software and/or firmware) executable on one or more hardware processing circuits.

A “memory device” can refer to any of a dynamic or static random access memory (a DRAM or SRAM) device, an erasable and programmable read-only memory (EPROM) device, an EEPROM device, or a flash memory device.

FIGS. 2, 3, and 6 are flow diagrams of processes including tasks performed in depicted orders. In other examples, the tasks of any of the processes may be performed in a different order, some of the tasks may be omitted, and other tasks may be added.

A “BMC” can refer to a specialized service controller that monitors the physical state of an electronic device using sensors and communicates with a remote management system (that is remote from the electronic device) through an independent “out-of-band” connection. The BMC can perform management tasks to manage components of the electronic device. Examples of management tasks that can be performed by the BMC can include any or some combination of the following: power control to perform power management of the electronic device (such as to transition the electronic device between different power consumption states in response to detected events), thermal monitoring and control of the electronic device (such as to monitor temperatures of the electronic device and to control thermal management states of the electronic device), fan control of fans in the electronic device, system health monitoring based on monitoring measurement data from various sensors of the electronic device, remote access of the electronic device (to access the electronic device over a network, for example), remote reboot of the electronic device (to trigger the electronic device to reboot using a remote command), system setup and deployment of the electronic device, system security to implement security procedures in the electronic device, and so forth.

In some examples, the BMC can provide so-called “lights-out” functionality for the electronic device. The lights out functionality may allow a user, such as a systems administrator, to perform management operations on the electronic device even if an OS is not installed or not functional on the electronic device.

Moreover, in some examples, the BMC can run on auxiliary power provided by an auxiliary power source; as a result, the electronic device does not have to be powered on to allow the BMC to perform the BMC's operations. The auxiliary power source is separate from a primary power supply that supplies powers to other components (e.g., a main processor, a memory, an I/O device, etc.) of the electronic device.

A storage medium (e.g., 400 in FIG. 4) can include any or some combination of the following: a semiconductor memory device such as a DRAM or SRAM device, an EPROM device, an EEPROM device, or a flash memory device; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause an electronic device to:
obtain a certificate issued by a certificate authority;
trigger, based on the certificate, a memory module verification process;
access, as part of the memory module verification process, memory module-related information from a memory module of the electronic device, wherein the memory module-related information comprises a plurality of information elements from a plurality of different types of components in the memory module;
determine a verification status of the memory module based on measurements of the plurality of information elements from the plurality of different types of components in the memory module; and
control activation of the memory module based on the verification status.

2. The non-transitory machine-readable storage medium of claim 1, wherein the instructions upon execution cause the electronic device to obtain the certificate from the certificate authority by sending an access request to the certificate authority.

3. The non-transitory machine-readable storage medium of claim 1, wherein the certificate comprises a feature control information element settable to an active value to indicate that the memory module verification process of the memory module is to be triggered.

4. The non-transitory machine-readable storage medium of claim 1, wherein the triggering of the memory module verification process, the accessing of the memory module-related information, the determining of the verification status of the memory module, and the controlling of the activation of the memory module are performed by a management controller.

5. The non-transitory machine-readable storage medium of claim 4, wherein the certificate is obtained during a startup of the electronic device, the certificate is signed with a private key, and the instructions upon execution cause the electronic device to:
send the signed certificate to the management controller.

6. The non-transitory machine-readable storage medium of claim 5, wherein instructions upon execution cause the electronic device to:
validate the signed certificate at the management controller using a public key obtained from a public key infrastructure that includes the certificate authority.

7. The non-transitory machine-readable storage medium of claim 1, wherein the memory module-related information comprises information from a module control device that is a member of the plurality of different types of components in the memory module, the module control device to perform a control task relative to memory devices in the memory module.

8. The non-transitory machine-readable storage medium of claim 7, wherein the module control device comprises a Registered Clock Driver to receive a memory access instruction from a requester and send the memory access instruction to a memory device in the memory module.

9. The non-transitory machine-readable storage medium of claim 7, wherein the module control device comprises a power management control module to manage power for the memory devices in the memory module.

10. The non-transitory machine-readable storage medium of claim 1, wherein the memory module-related information comprises information from a serial presence detect (SPD) memory that is a member of the plurality of different types of components in the memory module.

11. The non-transitory machine-readable storage medium of claim 1, wherein the memory module-related information comprises identification information from a memory device that is a member of the plurality of different types of components in the memory module.

12. The non-transitory machine-readable storage medium of claim 1, wherein the instructions upon execution cause the electronic device to:
determine the verification status of the memory module based on comparing a value derived from the memory module-related information to a reference value in a manifest stored in the electronic device.

13. The non-transitory machine-readable storage medium of claim 12, wherein the manifest was created during a manufacture of the electronic device.

14. The non-transitory machine-readable storage medium of claim 12, wherein the manifest was populated responsive to an authorized update of the memory module.

15. The non-transitory machine-readable storage medium of claim 1, wherein the instructions upon execution cause the electronic device to control the activation of the memory module by enabling or disabling power to the memory module.

16. An electronic device comprising:
a memory module connector for a memory module; and
a controller to:
obtain a certificate issued by a certificate authority;
determine a value of a feature control information element in the certificate;
trigger, based on the value of the feature control information element in the certificate, a memory module verification process;
access, as part of the memory module verification process, memory module-related information from the memory module;
determine a verification status of the memory module based on the memory module-related information; and
control activation of the memory module based on the verification status.

17. The electronic device of claim 16, wherein the controller is to:
apply a hash function on the memory module-related information to derive a hash value; and
determine the verification status of the memory module based on comparing the hash value to a reference hash value in a manifest.

18. The electronic device of claim 16, wherein the memory module-related information comprises a plurality of module-related information elements from a plurality of components in the memory module.

19. A method comprising:
sending, by an electronic device, an access request to a certificate authority;
receiving, by the electronic device, a certificate issued by the certificate authority as a response to the access request;
triggering, by a controller based on a feature control information element in the certificate, a memory module verification process;
accessing, by the controller as part of the memory module verification process, memory module-related information elements from respective components in a memory module of the electronic device;
applying, by the controller, a measurement of the memory module-related information elements to derive measurement values;
determining, by the controller, a verification status of the memory module based on comparing the derived measurement values to reference measurement values; and
controlling, by the controller, activation of the memory module based on the verification status.

20. The method of claim 19, further comprising:
validating, by the controller, the certificate before triggering the memory module verification process.
